(19) United States
(12) Patent Application Publication
(10) Pub. No.: US 2016/0191451 A1
(43) Pub. Date: Jun. 30, 2016

(54) E-MAIL STATUS NOTIFICATION SYSTEM AND METHOD

(71) Applicant: PECAN TECHNOLOGIES INC, Road Town Tortola (VG)

(72) Inventor: Ben VOLACH, Haifa (IL)

(73) Assignee: PECAN TECHNOLOGIES INC, Road Town Tortola (VG)

(21) Appl. No.: 14/900,175

(22) PCT Filed: Jun. 26, 2014
(86) PCT No.: PCT/IB14/62616

§ 371 Date: Dec. 21, 2015

Related U.S. Application Data
(60) Provisional application No. 61/839,398, filed on Jun. 26, 2013.

(51) Int. Cl. H04L 12/58

(52) U.S. Cl. CPC H04L 51/34

(57) ABSTRACT

A system for alerting e-mail activity status. The system has at least one e-mail server for integrating N e-mail accounts, at least one second server communicating with the e-mail server adapted to monitor at the e-mail server; at least one computer readable medium (CRM) adapted to receiving an e-mail alert wherein the second server identifies activity status in the e-mail server according to a set of predetermined parameters. The second server alerts the CRM on the activity status. The parameters may consist of entries to e-mail accounts type of actions performed in an e-mail account and other activities and events. The invention further comprises methods of applying the aforementioned system.

### FIELD OF THE INVENTION

The present invention relates to the field of transferring electronic data between electronic devices, more specifically, it relates to the field of transferring data relating to a presence status of a user.

### BACKGROUND

Traditionally, instant messaging services provide the availability (presence status) of a user, informing his friends whether the user is available for communication, whether he is online or whether he is busy, various presence statuses are available to enhance user experience.

However, for E-mail services, there was little change in the last decade, and the presence information related to this service, if available, is based on the user's instant messaging account and its related status.

For example, US 20080244026 patent application “Real-Time Notification of Presence Changes” discloses notifying a user from a group of users on the presence status of another user from the same group. However, the application does not disclose notification of an e-mail status, it notifies only on the presence status for communication.

There is therefore a long unmet need for a system that will notify user's on the presence status of an e-mail account or user using an intelligent rule engine.

### SUMMARY OF THE INVENTION

It is an object of the current invention to disclose a first system for alerting on an e-mail activity status comprising:
a. at least one e-mail server having first instructions thereon for integrating N e-mail accounts; N is an integer larger than zero;
b. at least one second server in communication with the e-mail server, at least one second server is adapted to monitor at least one of the e-mail server;
c. at least one computer readable medium (CRM) adapted to receiving an e-mail alert;
wherein at east one second server identifies activity status in at least one of the e-mail server according to a set of predetermined parameters; further wherein at least one second server alerts the CRM on the activity status.

It is another object of the current invention to disclose the first system as described above, wherein the parameters are selected from a group consisting of; number of entries to an e-mail account selected from the N e-mail accounts, number of entries to any e-mail account selected from the N-e-mail accounts, type of actions performed in an e-mail account selected from the N e-mail accounts, time length of being active in an e-mail account selected from the N e-mail accounts, read at least one e-mail, delete at least one e-mail, flag at least one e-mail, label at least one e-mail, move at least one e-mail to a folder, rename at least one folder, arrange folders, create folder, send at least one e-mail, draft at least one e-mail, reply to at least one e-mail, reply all to at least one e-mail, forward at least one e-mail, share at least one e-mail, open attachment from within at least one e-mail, open link from within at least one email, download at least one e-mail headers, download at least one e-mail body, performing search operation from within at least one e-mail client, login time, logout time, device and IP used per e-mail session, login while home network or roaming, email application or applications used to access the e-mail account, account activated or deactivated, account reached quota limit, e-mail notification was accessed, e-mail was accessed from a forwarded e-mail account, an e-mail its subset or a derivative was accessed from any program, any interaction with the e-mail, any manipulation of the e-mail, any interaction or manipulation with any instance of the e-mail, any interaction or manipulation of any subset or derivative of the e-mail and a combination thereof.

It is another object of the current invention to disclose the first system as described above, wherein the communication between the second server and the e-mail server is done via an e-mail agent.

It is another object of the current invention to disclose the first system as described above, wherein the second server is adapted to ignore at least one of rules of at least one of the N e-mail accounts.

It is another object of the current invention to disclose the first system as described above, wherein the CRM is integrated in a device selected from a group consisting of: mobile device, personal computer, tablet, laptop and any other electronic device comprising communication mean.

It is another object of the current invention to disclose the first system as described above, wherein each of at least one e-mail server comprises different set of parameter for identification of the activity status.

It is another object of the current invention to disclose the first system as described above, wherein the CRM and at least one of the N e-mail accounts are communicating via a third party.

It is another object of the current invention to disclose the first system as described above, wherein the parameters are determined by external activity status software.

It is another object of the current invention to disclose the first system as described above, wherein the second server stores the monitor data in a cache.

It is another object of the current invention to disclose the first system as described above, wherein the second server alerts at least one of the N e-mail accounts on the activity status.

It is another object of the current invention to disclose the first system as described above, additionally comprising at least one blocking module integrated in at least one e-mail server adapted to block the second server monitoring.

It is another object of the current invention to disclose the first system as described above, wherein the monitoring server additionally analyses activity of the user of the e-mail server.
It is an object of the current invention to disclose a first method for alerting on an e-mail activity status comprising steps of:
   a. connecting via a monitor server, to an e-mail server integrating e-mail accounts; N is an integer larger than zero;
   b. monitoring via the monitor server, activity of a first e-mail account selected from the N e-mail accounts;
   c. providing a computer readable medium (CRM) adapted to receive an e-mail alert from at least one of the N e-mail accounts;
   wherein the method additionally comprising steps of:
   d. determining activity status of the e-mail server according to a set of predetermined parameters; and
   e. alerting the CRM on the activity status.

It is another object of the current invention to disclose the first method as described above, wherein the parameters are selected from a group consisting of: number of entries to an e-mail account selected from the N e-mail accounts, number of entries to any e-mail account selected from the N-e-mail accounts, type of actions performed in an e-mail account selected from the N e-mail accounts, time length of being active in an e-mail account selected from the N accounts, read at least one e-mail, delete at least one e-mail, flag at least one e-mail, label at least one e-mail, move at least one e-mail to a folder, rename at least one folder, mange folders, create folder, send at least one e-mail, draft at least one e-mail, reply to at least one e-mail, reply all to at least one e-mail, forward at least one e-mail, share at least one e-mail, open attachment from within at least one e-mail, open link from within at least one e-mail, download at least one e-mail headers, download at least one e-mail body, performing search operation from within at least one e-mail client, login time, logout time, device and IP used per e-mail session, login while home network or roaming, e-mail application or applications used to access the e-mail account, account activated or deactivated, account reached quota limit, e-mail notification was accessed, e-mail was accessed from a forwarded e-mail account, an e-mail its subset or a derivative was accessed from any program, any interaction with the e-mail, any manipulation of the e-mail, any interaction or manipulation with any instance of the e-mail, any interaction or manipulation of any subset or derivative of the e-mail and a combination thereof.

It is another object of the current invention to disclose the first method as described above, wherein step (a) is done by an e-mail agent.

It is another object of the current invention to disclose the first method as described above, additionally comprising step of ignoring e-mail rules by the monitor server.

It is another object of the current invention to disclose the first method as described above, wherein the CRM is integrated in a device selected from a group consisting of: mobile device, personal computer, tablet, laptop and any other electronic device comprising communication mean.

It is another object of the current invention to disclose the first method as described above, additionally comprising step of providing each of at least one e-mail server with different set of parameters for identification of the activity status.

It is another object of the current invention to disclose the first method as described above, additionally comprising step of communicating between the CRM and the and at least one of the N e-mail accounts via a third party.

It is another object of the current invention to disclose the first method as described above, additionally comprising step of determining the parameters by external activity status software.

It is another object of the current invention to disclose the first method as described above, additionally comprising step of storing data monitored by the monitoring server in a cache.

It is another object of the current invention to disclose the first method as described above, additionally comprising step of alerting at least one of the N e-mail accounts on the activity status by the second server.

It is another object of the current invention to disclose the first method as described above, additionally comprising step of providing at least one blocking module integrated in at least one e-mail server adapted for blocking the second server monitoring.

It is another object of the current invention to disclose the first method as described above, additionally comprising step of analyzing activity of the user of the e-mail server by the monitoring server.
It is an object of the current invention to disclose a second system for g on an e-mail activity status comprising:
   a. at least one e-mail client having first instructions thereon integrating N accounts; N is an integer larger than zero;
   b. at least one e-mail agent adapted to identify e-mail client activity;
   c. at least one server in communication with the e-mail agent; at least one server is adapted to monitor at least one of the e-mail agent;
   d. at least one computer readable medium (CRM) adapted to receive e-mail alert from at least one of the N e-mail accounts;
   wherein at least one server identifies activity status in at least one of the e-mail client according to a set of predetermined parameters; further wherein at least one server alerts the CRM on the activity status.

It is another object of the current invention to disclose the second system as described above, wherein the parameters are selected from a group consisting of: number of entries to an e-mail account selected from the N e-mail accounts, number of entries to any e-mail account selected from the N-e-mail accounts, type of actions performed, in an e-mail account selected from the N e-mail accounts, time length of being active in an e-mail account selected from the N e-mail accounts, read at least one e-mail, delete at least one e-mail, flag at least one e-mail, label at least one e-mail, move at least one e-mail to a folder, rename at least one folder, arrange folders, create folder, send at least one e-mail, draft at least one e-mail, reply to at least one e-mail, reply all to at least one e-mail, forward at least one e-mail, share at least one e-mail, open attachment from within at least one e-mail, open link from within at least one e-mail, download at least one e-mail headers, download at least one e-mail body, performing search operation from within at least one e-mail client, login time, logout time, device and IP used per e-mail session, login while home network or roaming, e-mail application or applications used to access the e-mail account, account activated or deactivated, account reached quota limit, e-mail notification was accessed, e-mail was accessed from a forwarded e-mail account, an e-mail its subset or a derivative was accessed from any program, any interaction with the e-mail, any manipulation of the e-mail, any interaction or manipulation with any instance of the e-mail, any interaction or manipulation of any subset or derivative of the e-mail and a combination thereof.

It is another object of the current invention to disclose the second system as described above, wherein the server is adapted to ignore e-mail rules of at least one of the N e-mail accounts.

It is another object of the current invention to disclose the second system as described above, wherein the CRM is integrated in a device selected from a group consisting of: mobile device, personal computer, tablet, laptop and any other electronic device comprising communication mean.

It is another object of the current invention to disclose the second system as described above, wherein each of the N e-mail accounts comprises different set of parameter for identification of the activity status.

It is another object of the current invention to disclose the second system as described above, wherein the CRM and at least one of the N e-mail accounts are communicating via a third party.

It is another object of the current invention to disclose the second system as described above, wherein the parameters are determined by external activity status software.

It is another object of the current invention to disclose the second system as described above, wherein the server stores the monitor data in a cache.

It is another object of the current invention to disclose the second system as described above, wherein the server alerts at least one of the N e-mail accounts on the activity status.

It is another object of the current invention to disclose the second system as described above, additionally comprising at least one blocking module in communication with the e-mail client adapted. to block the second server monitoring.

It is another object of the current invention to disclose the second system as described above, wherein the monitoring server additionally analyses activity of the e-mail
It is an object of the current invention to disclose a second method for alerting on an e-mail activity status comprising steps of:
   a. connecting via a monitor server, to an e-mail agent; the e-mail agent is associated with an e-mail client integrating N e-mail accounts; N is an integer larger than zero;
   b. monitoring via the monitor server, activity of a first e-mail account selected from the N e-mail accounts;
   c. providing a computer readable medium (CRM) adapted for receiving e-mail alert from at least one of the N e-mail accounts;
   wherein the method additionally comprising steps of:
   d. determining activity status of the e-mail client according to a set of predetermined parameters; and
   e. alerting the CRM on the activity status.

It is another object of the current invention to disclose the second method as described above, wherein the parameters are selected from a group consisting of: number of entries to an e-mail account selected from the N e-mail accounts, number of entries to any e-mail account selected from the N-e-mail accounts, type of actions performed in an e-mail account selected from the N e-mail accounts, time length of being active in an e-mail account selected from the N accounts, read at least one e-mail. delete at least one e-mail, flag at least one e-mail, label at least one e-mail, move at least one e-mail to a folder, rename at least one folder. arrange folders, create folder, send at least one e-mail, draft at least one e-mail, reply to at least one e-mail, reply all to at least one e-mail, forward at least one e-mail share at least one e-mail, open attachment from within at least one e-mail, open link from within at least one e-mail, download at least one e-mail headers, download at least one e-mail body, performing search operation from within at least one e-mail client, login time, logout time, device and IP used per e-mail session, login while home network or roaming, e-mail application or applications used to access the e-mail account, account activated, or deactivated, account reached quota limit, e-mail notification was accessed, e-mail was accessed from a forwarded e-mail account, an e-mail its subset or a derivative was accessed from any program, any interaction with the e-mail, any manipulation of the e-mail, any interaction or manipulation with any instance of the e-mail, any interaction or manipulation of any subset or derivative of the e-mail and a combination thereof.

It is another object of the current invention to disclose the second method as described above, additionally comprising step of ignoring e-mail rules of at least one of the N e-mail accounts by the monitor server.

It is another object of the current invention to disclose the second method as described above, additionally comprising step of integrating the CRM in a device selected from a group consisting of: mobile device, personal computer, tablet, laptop and any other electronic device comprising communication mean.

It is another object of the current invention to disclose the second method as described above, additionally comprising step of providing each of the N e-mail accounts with a different set of parameter for identification of the activity status.

It is another object of the current invention to disclose the second method as described above, additionally comprising step of communicating between the CRM and at least one of the N e-mail accounts via a third party.

It is another object of the current invention to disclose the second method as described above, additionally comprising step of determining the parameters by external activity status software.

It is another object of the current invention to disclose the second method as described above, additionally comprising step of storing at least some of data monitored by the server in a cache.

It is another object of the current invention to disclose the second method as described above, additionally comprising step of alerting at least one of the N e-mail accounts on the activity status.

It is another object of the current invention to disclose the second method as described above, additionally comprising step of providing at least one blocking module communicating with the e-mail client; the blocking module is provided for blocking the second server monitoring.

It is another object of the current invention to disclose the second method as described above, additionally comprising step of analyzing activity of the e-mail client by the monitoring server.
It is an object of the current invention to disclose a third system for alerting an e-mail activity status comprising:
   a. a first computer readable medium (FORM) having first instructions thereon for (i) executing a plurality of N actions; and (ii) retrieving information associated with at least one e-mail account; N is an integer larger than zero;
   b. at least one server in communication with the FCRM; at least one server is adapted to monitor performance of at least one first action selected from the N actions;
   c. a second computer readable medium (SCRM) having second instructions thereon for receiving notification associated with the first action;
   wherein at least one server determines activity status of the e-mail account according to a set of predetermined parameters; the predetermined parameters are in association with the performance of at least one first action; further wherein at least one server alerts the SCRM on the e-mail activity status.

It is another object of the current invention to disclose the third system as described above, wherein the parameters are selected from a group consisting of: number of entries to the e-mail account, number of entries to the e-mail account, type of actions performed in the e-mail account, time length of being active in the e-mail account, number of actions selected from the N actions taken on the FCRM, duration of usage at least one of the N actions, type of usage of at least one of the N action , read at least one e-mail, delete at least one e-mail, flag at least one e-mail, label at least one e-mail, move at least one e-mail to a folder, rename at least one folder, arrange folders, create folder, send at least one e-mail, draft at least one e-mail, reply to at least one e-mail, reply all to at least one e-mail, forward at least one e-mail, share at least one e-mail, open attachment from within at least one e-mail, open link from within at least one e-mail, download at least one e-mail headers, download at least one e-mail body, performing search operation from within at least one e-mail client, login time, logout time, device and. IP used per e-mail session, login while home network or roaming, e-mail application or applications used to access the e-mail account, account activated or deactivated, account reached quota limit, e-mail notification was accessed, e-mail was accessed from a forwarded. e-mail account, an e-mail its subset or a derivative was accessed from any program, any interaction with the e-mail, any manipulation of the e-mail, any interaction or manipulation with any instance of the e-mail, any interaction or manipulation of any subset or derivative of the e-mail and a combination thereof.

It is another object of the current invention to disclose the third system as described above, wherein the server is adapted to ignore e-mail rules of at least one e-mail account.

It is another object of the current invention to disclose the third system as described, above, wherein either one of the FCRM, the SCRM is integrated in a device selected from a group consisting of: mobile device, personal computer, tablet, laptop and any other electronic device comprising communication mean.

It is another object of the current invention to disclose the third system as described above, wherein each of the N actions is provided with a different set of parameter for identification of the activity status.

It is another object of the current invention to disclose the third system as described above, wherein the SCRM and at least one of the N actions are communicating via a third party.

It is another object of the current invention to disclose the third system as described above, wherein the parameters are determined by external activity status software.

It is another object of the current invention to disclose the third system as described above, wherein at least some of data monitored by the server is stored in a cache.

It is another object of the current invention to disclose the third system as described above, wherein either one of the e-mail account, the FCRM is notified on the activity status.

It is another object of the current invention to disclose the third system as described above, additionally comprising at least one blocking module in communication with the FCRM; the blocking module is provided for blocking the server monitoring.

It is another object of the current invention to disclose the third system as described above, wherein the server additionally analyzes activity of the FCRM.
It is an object of the current invention to disclose a third method for alerting an e-mail activity status comprising steps of:
   a. communicating by a monitor server, to a first computer readable medium (FCRM) operating N actions; one of the actions is retrieving information associated, with at least one e-mail account; N is an integer larger than zero;
   b. monitoring by the monitor server, performance of at least one first action selected from the N actions;
   c. communicating between a second computer readable medium (SCRM) and the first action;
   wherein the method additionally comprising steps of:
   d. determining by the monitor server activity status of the e-mail account according to a set of predetermined parameters;
   e. alerting the SCRM on the e-mail activity status by the monitor server.

It is another object of the current invention to disclose the third method as described above, wherein the parameters are selected from a group consisting of: number of entries to the e-mail account, number of entries to the e-mail account, type of actions performed in the e-mail account, time length of being active in the e-mail account, number of actions selected from the N actions taken on the FCRM, duration of usage at least one of the N actions, type of usage of at least one of the N action, read at least one e-mail, delete at least one e-mail, flag at least one e-mail, label at least one e-mail, move at least one e-mail to a folder, rename at least one folder, arrange folders, create folder, send at least one e-mail, draft at least one e-mail, reply to at least one e-mail, reply all to at least one e-mail, forward at least one e-mail, share at least one e-mail, open attachment from within at least one e-mail, open link from within at least one e-mail, download at least one e-mail headers, download at least one e-mail body, performing search operation from within at least one e-mail client, login time, logout time, device and IP used per e-mail session, login while home network or roaming, e-mail application or applications used to access the e-mail account, account activated or deactivated, account reached quota limit, e-mail notification was accessed, e-mail was accessed from a forwarded e-mail account, an e-mail its subset or a derivative was accessed from any program, any interaction with the e-mail, any manipulation of the e-mail, any interaction or manipulation with any instance of the e-mail, any interaction or manipulation of any subset or derivative of the e-mail and a combination thereof.

It is another object of the current invention to disclose the third method as described above, additionally comprising step of ignoring e-mail rules of at least one e-mail account by the monitor server.

It is another object of the current invention to disclose the third method as described above, additionally comprising step of integrating either one of the FCRM, the SCRM in a device selected from a group consisting of: mobile device, personal computer, tablet, laptop and any other electronic device comprising communication mean.

It is another object of the current invention to disclose the third method as described above, additionally comprising step of providing each of the N actions with a different set of parameter for identification of the activity status.

It is another object of the current invention to disclose the third method as described above, additionally comprising step of communicating between the SCRM and at least one of the N actions via a third party.

It is another object of the current invention to disclose the third method as described above, additionally comprising step of determining the parameters by external activity status software.

It is another object of the current invention to disclose the third method as described above, additionally comprising step of storing at least some of data monitored by the monitor server in a cache.

It is another object of the current invention to disclose the third method as described above, additionally comprising step of notifying either one of the e-mail account, the FCRM on the activity status.

It is another object of the current invention to disclose the third method as described above, additionally comprising step of providing at least one blocking module in communication with the FCRM; the blocking module is provided for blocking the server monitoring.

It is another object of the current invention to disclose the third method as described above, additionally comprising step of analyzing activity of the FCRM by the server.
It is an object of the current invention to disclose a fourth system for alerting an e-mail activity status comprising:
   a. a first computer readable medium (FCRM) having first instructions thereon for (i) executing a plurality of N actions; and (ii) retrieving information associated with at least one e-mail account; the FCRM is having at least one identification parameter; N is an integer larger than zero;
   b. at least one first server in communication with the FCRM; at least one first server receives notification of (i) at least one first action selected from the N actions; and (ii) at least one identification parameter;
   c. at least one second server in communication with the first server; at least one second server is adapted to monitor performance of at least one of the first action;
   d. a second computer readable medium (SCRM) having second instructions thereon for communicating with the first action;
   wherein at least one second server determines activity status of the e-mail account according to (i) a set of predetermined parameters; and (ii) at least one identification parameter; the predetermined parameters are in association with the performance of at least one first action; further wherein at least one server alerts the SCRM on the activity status.

It is another object of the current invention to disclose the fourth system as described above, wherein the parameters are selected from a group consisting of; number of entries to the e-mail account, number of entries to the e-mail account, type of actions performed in the e-mail account, time length of being active in the e-mail account, number of actions selected from the N actions taken on the FCRM, duration of usage at least one of the N actions, type of usage of at least one of the N action, read at least one e-mail, delete at least one e-mail, flag at least one e-mail, label at least one e-mail, move at least one e-mail to a folder, rename at least one folder, arrange folders, create folder, send at least one e-mail, draft at least one e-mail, reply to at least one e-mail, reply all to at least one e-mail, forward at least one e-mail, share at least one e-mail, open attachment from within at least one e-mail, open link from within at least one e-mail, download at least one e-mail headers, download at least one e-mail body, performing search operation from within at least one e-mail client, login time, logout time, device and IP used per e-mail session, login while home network or roaming, e-mail application or applications used to access the e-mail account, account activated or deactivated, account reached quota limit, e-mail notification was accessed, e-mail was accessed from a forwarded e-mail account, an e-mail its subset or a derivative was accessed from any program, any interaction with the e-mail, any manipulation of the e-mail, any interaction or manipulation with any instance of the e-mail, any interaction or manipulation of any subset or derivative of the e-mail and a combination thereof.

It is another object of the current invention to disclose the fourth system as described above, wherein the second server is adapted to ignore e-mail rules of at least one e-mail account.

It is another object of the current invention to disclose the fourth system as described above, wherein either one of the FCRM, the SCRM is integrated in a device selected from a group consisting of: mobile device, personal computer, tablet, laptop and any other electronic device comprising communication mean.

It is another object of the current invention to disclose the fourth system as described above, wherein each of the N actions is provided with a different set of parameter for identification of the activity status.

It is another object of the current invention to disclose the fourth system as described above, wherein the SCRM and at least one of the N actions are communicating via a third party.

It is another object of the current invention to disclose the fourth system as described above, wherein the parameters are determined by external activity status software.

It is another object of the current invention to disclose the fourth system as described above, wherein at least some of data monitored by the second server is stored in a cache.

It is another object of the current invention to disclose the fourth system as described above, wherein either one of the e-mail account, the FCRM is notified on the activity status.

It is another object of the current invention to disclose the fourth system as described above, additionally comprising at least one blocking module in communication with the FCRM; the blocking module is provided for blocking the second server monitoring.

It is another object of the current invention to disclose the fourth system as described above, wherein the second server additionally analyzes activity of the FCRM.

It is an object of the current invention to disclose a fourth method for alerting an e-mail activity status comprising steps of:
a. communicating between (i) least one software operating on a first computer readable medium (FCRM) associated with at least one e-mail account; and (ii) the software server;
b. receiving by the software server; (i) notification on activity of the software; and (ii) identification of the CRM;
c. communicating between (i) a monitor server; and (ii) the software server;
d. monitoring by the monitor server, performance of the software;
e. communicating between a second computer readable medium (SCRM) and the software;
wherein the method additionally comprising steps of:
f. determining by the monitor server activity status of the e-mail account according to a set of predetermined parameters; the parameters are in association with the performance of the software
g. alerting the SCRM on the e-mail activity status by the monitor server.

It is another object of the current invention to disclose the fourth method. as described above, wherein the parameters are selected from a group consisting of: number of entries to the e-mail account, number of entries to the e-mail account, type of actions performed in the e-mail account, time length of being active in the e-mail account, number of actions selected from the N actions taken on the FORM, duration of usage at least one of the N actions, type of usage of at least one of the N action , read at least one e-mail, delete at least one e-mail, flag at least one e-mail, label at least one e-mail, move at least one e-mail to a folder, rename at least one folder, arrange folders, create folder, send at least one e-mail, draft at least one e-mail, reply to at least one e-mail, reply all to at least one e-mail, forward at least one e-mail, share at least one e-mail, open attachment from within at least one e-mail, open link from within at least one e-mail, download at least one e-mail headers, download at least one e-mail body, performing search operation from within at least one e-mail client, login time, logout time, device and IP used per e-mail session, login while home network or roaming, e-mail application or applications used to access the e-mail account, account activated or deactivated, account reached quota limit, e-mail notification was accessed, e-mail was accessed from a forwarded e-mail account, an e-mail its subset or a derivative was accessed from any program, any interaction with the e-mail, any manipulation of the e-mail, any interaction or manipulation with any instance of the e-mail, any interaction or manipulation of any subset or derivative of the e-mail and a combination thereof.

It is another object of the current invention to disclose the fourth method as described above additionally comprising step of ignoring e-mail rules of at least one e-mail account by the monitor server.

It is another object of the current invention to disclose the fourth method as described above, additionally comprising step of integrating either one of the FCRM, the SCRM in a device selected from a group consisting of: mobile device, personal computer, tablet, laptop and any other electronic device comprising communication mean.

It is another object of the current invention to disclose the fourth method as described above, additionally comprising step of providing each of at least one software with a different set of parameter for identification of the activity status.

It is another object of the current invention to disclose the fourth method as described above, additionally comprising step of communicating between the SCRM and at least one software via a third party.

It is another object of the current invention to disclose the fourth method as described above, additionally comprising step of determining the parameters by external activity status software.

It is another object of the current invention to disclose the fourth method as described above, additionally comprising step of storing at least some of data monitored by t le monitor server in a cache.

It is another object of the current invention to disclose the fourth method as described above, additionally comprising step of notifying either one of the e-mail account, the FCRM on the activity status.

It is another object of the current invention to disclose the fourth method as described above, additionally comprising step of providing at least one blocking module in communication with the FCRM; the blocking module is provided for blocking the monitor server.

It is another object of the current invention to disclose the fourth method as described above, additionally comprising step of analyzing activity of the FCRM by the monitor server.

### BRIEF DESCRIPTION OF THE DRAWINGS

In order to understand the invention and to see how it may be implemented in practice, a few preferred embodiments will now be described, by way of non-limiting example only, with reference to be accompanying drawings, in which:

FIG. 1 illustrates in a non-limiting manner a system for notifying on an e-mail presence status via an e-mail server;

FIG. 2 shows in a non-limiting manner a system notifying on an e-mail presence status via an e-mail client;

FIG. 3 describes in a non-limiting manner a system for notifying on an e-mail presence status via scan of actions performed on a device associated with the e-mail account;

FIG. 4 reveals in a non-limiting manner a system for notifying on an e-mail presence status via scan of a server operating actions performed on a device associated with the e-mail account;

FIG. 5 illustrates in a non-limiting manner a method for notifying on an e-mail presence status via an e-mail server;

FIG. 6 shows in a non-limiting manner a method for notifying on an e-matt presence status via an e-mail client;

FIG. 7 describes in a non-limiting manner a method for notifying on an e-mail presence status via scan of actions performed on a device associated with the e-mail account;

FIG. 8 reveals in a non-limiting manner a method for notifying on an e-mail presence status via scan of a server operating actions performed on a device associated with the e-mail account;

FIG. 9 illustrates a detailed structure of a system for detecting and notifying e-mail presence status; and

FIG. 10 describes a schematic view of a system for notification of an e-mail presence status divided into “client side” and “server side”.

### DETAILED DESCRIPTION OF THE INVENTION

The following description is provided so as to enable any person skilled in the art to make use of the invention and sets forth examples contemplated by the inventor of carrying out this invention. Various modifications, however, will remain apparent to those skilled in the art, since the generic principles of the present invention have been defined specifically. Also, it is to be understood that the phraseology and terminology employed herein is for the purpose of description and should not be regarded as limiting.

It is one object of the current invention to disclose a first system for alerting an e-mail activity status comprising:
a. at least one e-mail server having first instructions thereon for integrating N e-mail accounts; N is an integer larger than zero;
b. at least one second server in communication with the e-mail server; at least one second server is adapted to monitor at least one of the e-mail server;
c. at least one computer readable medium (CRM) in communication with at least one of the N e-mail accounts;
wherein at least one second server identifies activity status in at least one of the e-mail server according to a set of predetermined parameters; further wherein at least one second server alerts the CRM on the activity status.

It is one object of the current invention to disclose a first method for alerting on an e-mail activity status comprising steps of;
a. connecting via a monitor server, to an e-mail server integrating N accounts; N is an integer larger than zero;
b. monitoring via said monitor server, activity of a first e-mail account selected from the N e-mail accounts;
c. providing a computer readable medium (CRM) communicating with at least one of the N e-mail accounts;
wherein the method additionally comprising steps of:
d. determining activity status of the e-mail server according to a set of predetermined parameters; and
e. alerting the CRM on the activity status.

It is one object of the current invention to disclose a second system for alerting on an e-mail activity status comprising:
a. at least one e-mail client having first instructions thereon for integrating N e-mail accounts; N is an integer larger than zero;
b. at least one server in communication with the e-mail client; at least one server is adapted to monitor at least one of the e-mail client;
c. at least one computer readable medium (CRM) in communication with at least one of the N e-mail accounts;
wherein at least one server identifies activity status in at least one of e-mail client according to a set of predetermined parameters; further wherein at least one server alerts the CRM on the activity status.

It is one object of the current invention to disclose a second method for alerting on an e-mail activity status comprising steps of:
a. connecting via a monitor server, to an e-mail client integrating N e-mail accounts; N is an integer larger than zero;
b. monitoring viii the monitor server, the activity of a first e-mail account selected from the N e-mail accounts;
c. providing a computer readable medium (CRM) communicating with one of the N e-mail accounts;
wherein said method additionally comprising steps of:
d. determining activity status of the e-mail client according to a set of predetermined parameters; and
alerting the CRM on the activity status.

It is one object of the current invention to disclose a third system for alerting an e-mail activity status comprising:
a. a first computer readable medium (FCRM) having first instructions thereon for (i) executing a plurality of N actions; and (ii) retrieving information associated at least one e-mail account; N is an integer larger than zero;
b. at least one server in communication with the FCRM; at least one server is adapted to monitor performance of at least one first action selected from the N actions;
c. a second computer actable medium (SCRM) having second instructions thereon for communicating with the first action;
wherein at least one server determines activity status of the e-mail account according to a set of predetermined parameters; the predetermined parameters are in association with the performance of at least one first action; further wherein said at least one server alerts the SCRM on the e-mail activity status.

It is one object of the current invention to disclose a third method for alerting an e-mail activity status comprising:
a. communicating by a monitor server, to a first computer readable medium (FCRM) operating N actions; one of the actions is retrieving information associated with at least one e-mail account; said N is an integer larger than zero;
b. monitoring by the monitor server, performance of at least one first action selected from the N actions;
c. communicating between a second computer readable medium (SCRM) and the e-mail account;
wherein the method additionally comprising steps of:
d. determining by the monitor server activity status of the e-mail account according to a set of predetermined parameters;
e. alerting the SCRM on the e-mail activity is by the monitor server.

It is one object of the current invention to disclose a fourth system for alerting an e-mail activity status comprising:
a. a first computer readable medium (FCRM) having first instructions thereon for (i) executing a plurality of N actions; and (ii) retrieving information associated at least one e-mail account; the FCRM is having at least one identification parameter; N is an integer larger than zero;
b. at least one first server in communication with the FCRM; at least one first server receives notification of (i) at least one first action selected from the N actions; and (ii) at least one identification parameter;
c. at least one second server in communication with the first server; at least one second server is adapted to monitor performance of at least one of the first action;
d. a second computer readable medium (SCRM) having second instructions thereon for communicating with the first action;
wherein at least one second server determines activity status of the e-mail account according to (i) a set of predetermined parameters; and (ii) at least one identification parameter; the predetermined parameters are in association with the performance of at least one first action; further wherein at least one server alerts the SCRM on the activity status.

It is one object of the current invention to disclose a fourth method for alerting an e-mail activity status comprising:
a. communicating between (i) at least one software operating on a first computer readable medium (FCRM) associated with at least one e-mail account; and (ii) the software server;
b. receiving by the software server: (i) notification on activity software; and (ii) identification of the CRM;
c. communicating between (i) a monitor server; and (ii) the software server;
d. monitoring by the monitor server, performance of the software;
e. communicating between a second computer readable medium (SCRM) and the e-mail account;
wherein the method additionally comprising steps of:
f. determining by the monitor server activity status of the e-mail account according to a set of predetermined parameters; the parameters are in association with the performance of said software
g. alerting the SCRM on the e-mail activity status by the monitor server.

The term “e-mail presence status” refers hereinafter to any indicator which conveys ability and willingness status of a potential communication partner. This ability or willingness may be described as indicating whether the communication partner is “online/active” or any other status providing information on his availability. For example: “sent e-mail 5 minutes ago” “offline since 10 minutes ago”, “active on Facebook”, “reads messages”, “online with no actions taken in e-mail” etc.

The term “computer readable medium” refers hereinafter to any medium that is capable of storing or encoding a sequence of instructions for execution by a computer and that cause the computer to perform any one of the methodologies of the present invention, it includes, but is not limited to, solid-state memories, optical and magnetic disks, and carrier wave signals.

The term “application”, refers hereinafter to any software program adapted to be installed on a computer readable medium (for example: a smartphone).

The abbreviation “GUI” refers hereinafter to GRAPHICAL USER INTERFACE.

The abbreviation “MUA” refers hereinafter to MAIL USER AGENT.

The abbreviation “WUA” refers hereinafter to Watcher User Agent

The abbreviation “SMTP” refers hereinafter to SIMPLE MAIL TRANSFER PROTOCOL,

The abbreviation “IMPP” refers hereinafter to INSTANT MESSAGING AND PRESENCE PROTOCOL.

The abbreviation “MVP” refers hereinafter to EXTENSIBLE MESSAGING AND PRESENCE PROTOCOL.

The abbreviation “API” refers hereinafter to APPLICATION PROGRAMMING INTERFACE.

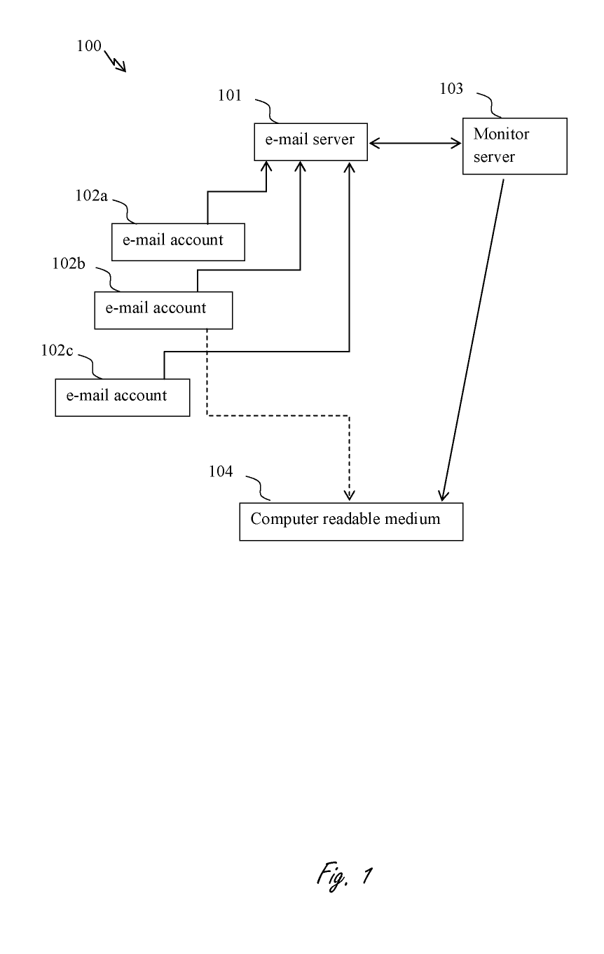

Reference is now made to FIG. 1 illustrating in a non-limiting the first system 100 as described. above for alerting on an e-mail activity status. The first system 100 comprising an e-mail server 101. The e-mail server is integrating a few different e-mail accounts 102a-c, at least one of these e-mail accounts, for example, account 102b, in conununication with a computer readable medium 104. There is a monitoring server 103 connected to both the e-mail server 101 and the computer readable medium 104. The computer readable medium (CRM) 104 is communicating with the e-mail account 102b, and the purpose of the current invention is to notify the CRM 104 on the e-mail presence status of the e-mail account 102 user. The CRM 104 is receiving this e-mail presence status notification vita the monitor server 103 which is adapted to scan the e-mail server 101 and decide on the e-mail presence status according to predetermined parameters regarding activity within the e-mail account 102b. Predetermined parameters might include among others any action performed on the e-mail account (e.g. login, logout, account activation, password change) or on one or more of the e-mails within the account (e.g. read, delete, mark as unread, forward, scroll up or down, mouse move, reply, share, move folder, label, open attachment, click on a link or any interaction or manipulation with any instance of said e-mail, any interaction or manipulation of any subset or derivative of said e-mails and a combination thereof.)

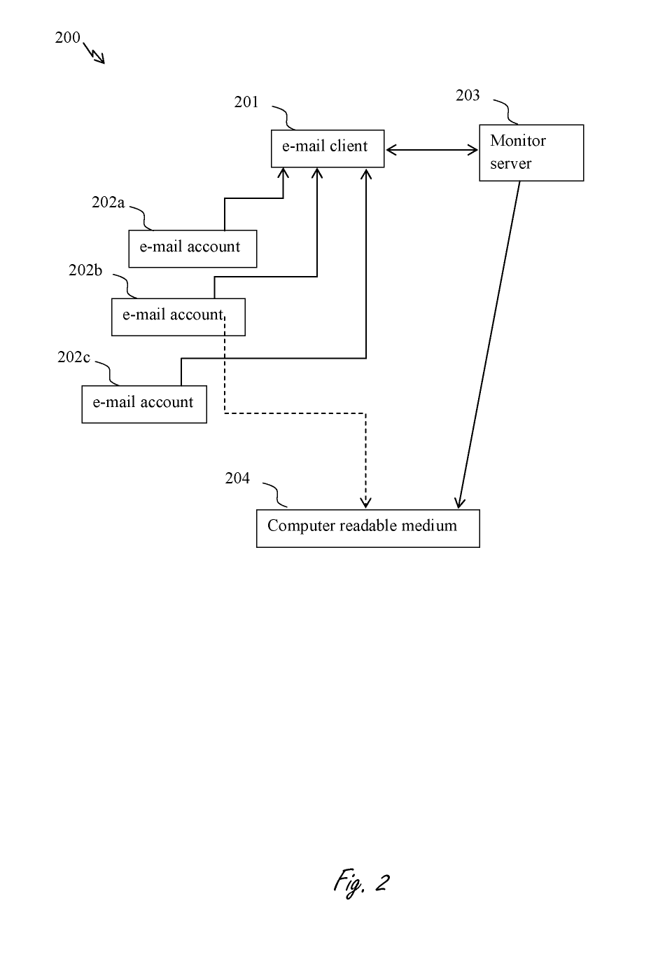

Reference is now made to FIG. 2 illustrating in a non-limiting manner a second system 200 for alerting on an e-mail presence status. The second system 200 comprising at least one e-mail client 201 integrating a plurality of e-mail accounts 202a-c, at least one of these e-mail accounts 202a-c, for example, e-mail account 202b is connected to a computer readable medium (CRM) 204. A monitor server 203 is adapted to connect to the e-mail client 201 in order to monitor the activity in one or more of the e-mail accounts 202a-c. Once the monitor detected the above mentioned activity is uses a predetermined set of parameters in order to set the e-mail presence status of the e-mail client 201. This e-mail status is sent via the monitor server 203 to the CRM 204.

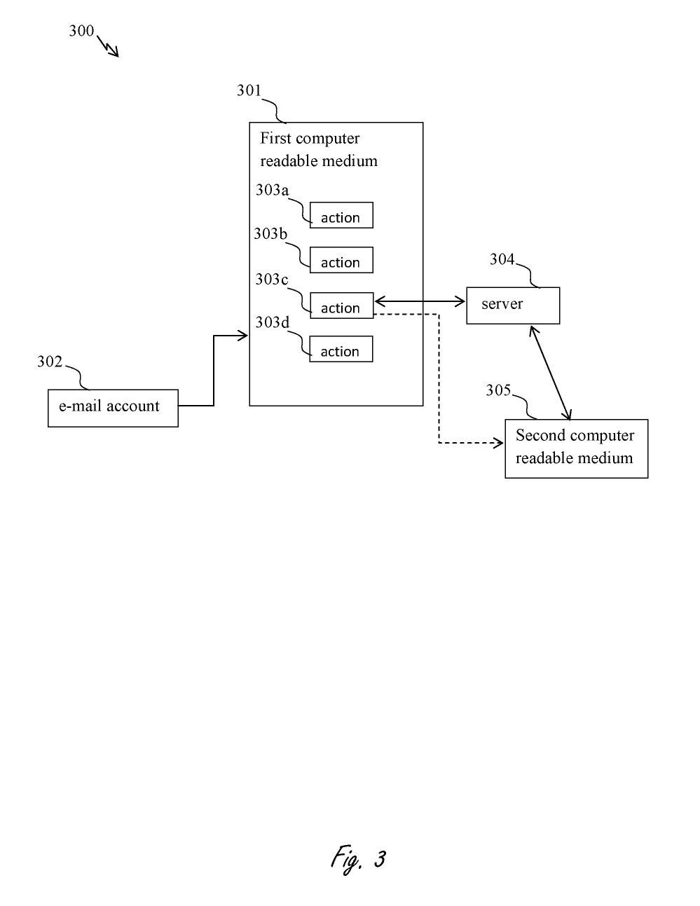

Reference is now made to FIG. 3, illustrating in a non-limiting manner a third system 300 for detecting an e-mail account 302 e-mail presence status. The e-mail account 302 is communicating with a first computer readable medium (FCRM) 301, This FCRM 301 has different actions 303a-d executing on it (for example, by means of an installed software or as part of the operating system installed on it). A server 304 is communicating with at least one of the actions 303a-d, for example, action 303c. The purpose of the server 304 is to detect certain predetermined parameters related to activity of the specific action 304d. Once the server has detected these predetermined parameters of activity, it sets the e-mail presence status of the e-mail account 302. At this point, the server 304 is adapted to notify a second computer readable medium (SCRM) 305 on the e-mail presence status of e-mail account 302.

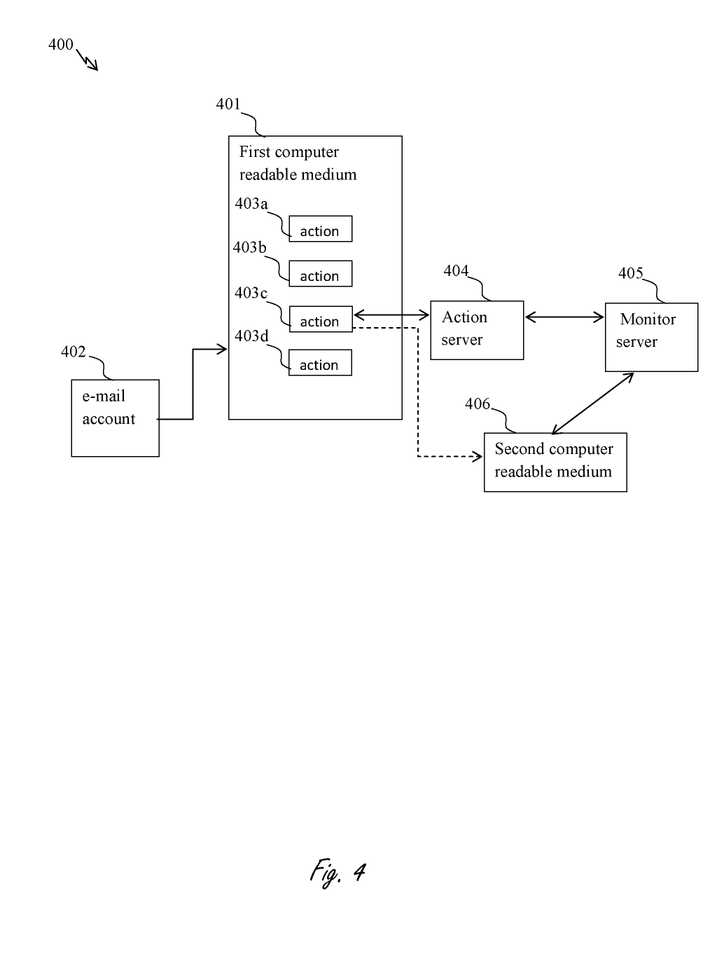

Reference is now made to FIG. 4 illustrating in a non-limiting manner a fourth system 400 for notifying on an e-mail presence status. The fourth system 400 comprises a first computer readable medium (FCRM) 401 having a plurality of actions 403a-d executing on it (for example, by means of an installed software or as part of the operating system installed on it). At least one of these actions 403a-d is connected to an action server 404 operating the action 403c. This action server 404 is monitored by a monitoring server 405. The monitoring server 405 is having a set of predetermined parameters for deciding on a e-mail presence status of the e-mail account. These predetermined parameters are related to the activity of the monitored action 403c. The e-mail presence status is determined by the monitor server 405 and reported to a second computer readable medium (SCRM) 406 which is communicating with the action 403c.

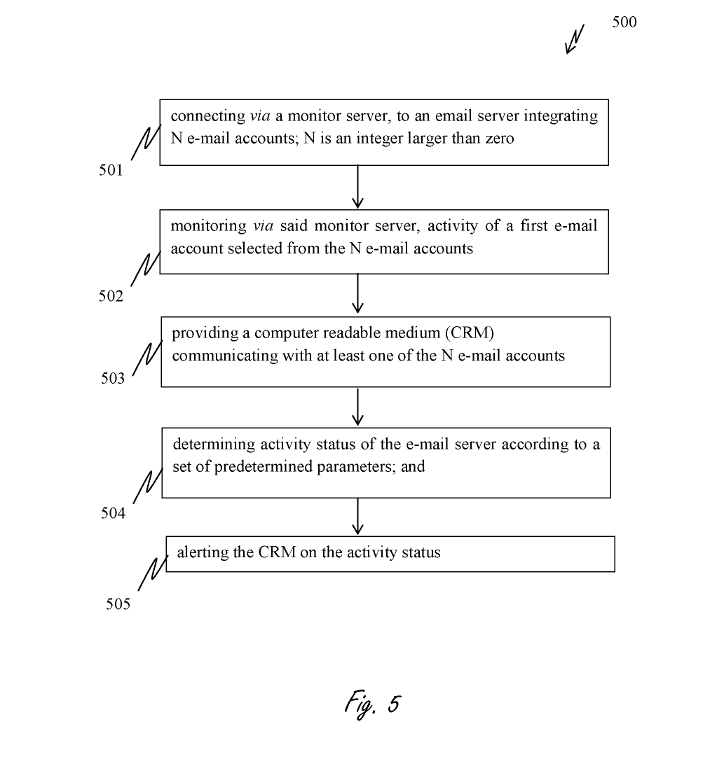

Reference is now made to FIG. 5, illustrating in a non-limiting manner a first method 500 for alerting on an e-mail activity status comprising:
a. step 501 of connecting via a monitor server, to an e-mail server integrating N e-mail accounts; N is an integer larger than zero;
b. step 502 of monitoring via said monitor server, activity of a first e-mail account selected from the N e-mail accounts;
c. step 503 of providing a computer readable medium (CRM) communicating with at least one of the N e-mail accounts;
wherein the method additionally comprising steps of:
d. step 504 of determining activity status of the e-mail server according to a set of predetermined parameters; and
e. step 505 of alerting the CRM on the activity status.

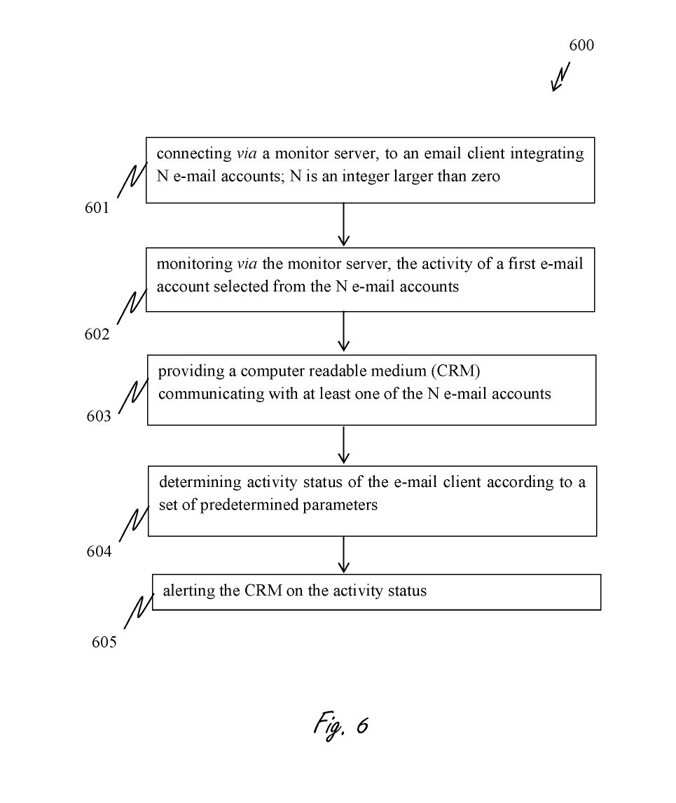

Reference is now made to FIG. 6 illustrating in a non-limiting a second method 600 for alerting on an e-mail activity status comprising:
a. step 601 of connecting via a monitor server, to an e-mail client integrating N e-mail accounts; N is an integer larger than zero;
b. step 602 of monitoring via the monitor server, the activity of a first e-mail account selected from the N e-mail accounts;
c. step 603 of providing a computer readable medium (CRM) communicating with at least one of the N e-mail accounts;
wherein said method additionally comprising steps of:
d. step 604 of determining activity status of the e-mail client according to a set of predetermined parameters; and
e. step 605 alerting the CRM on the activity status

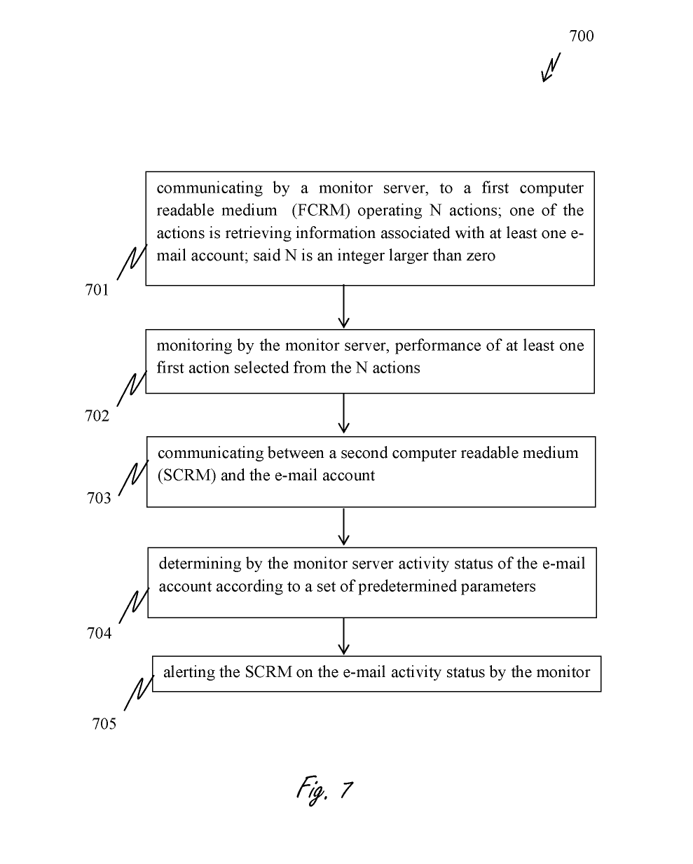

Reference is now made to FIG. 7 illustrating in a non-limiting a third method 700 for alerting an e-mail activity is comprising:
a. step 701 of communicating by a monitor server, to a first computer readable medium (FCRM) operating N actions; one of the actions is retrieving information associated with at least one e-mail account; said N is an integer larger than zero;
b. step 702 of monitoring by the monitor server, performance of at least one first action selected from the N actions;
c. step 703 of communicating between a second computer readable medium (SCRM) and the e-mail account;
wherein the method additionally comprising steps of:
d. step 704 of determining by the monitor server activity status of the e-mail account according to a set of predetermined parameters;
e. step 705 of alerting the SCRM on the e-mail activity status by the monitor server.

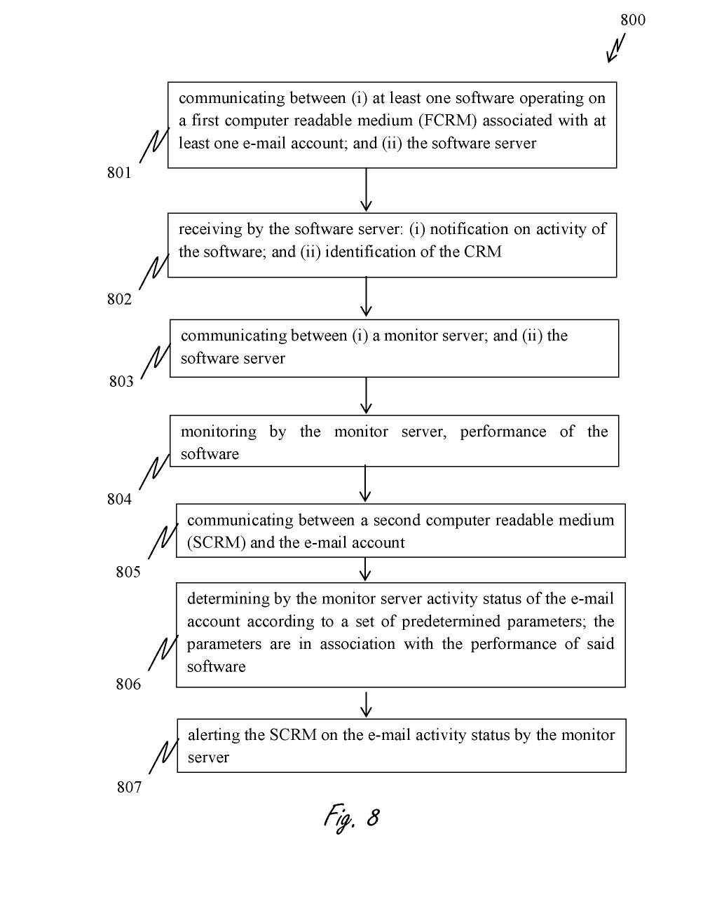

Reference is now made to FIG. 8 illustrating in a non-limiting a fourth method 800 for alerting an email activity status comprising;
a. step 801 of communicating between (i) at least one software operating on a first computer readable medium (FCRM) associated with at least one e-mail account; and (ii) the software server;
b. step 802 of receiving by the software server: (i) notification on activity of the software; and (ii) identification of the CRM;
c. step 803 of communicating between (i) a monitor server; and (ii) the software server;
d. step 804 of monitoring by the monitor server, performance of the software;
e. step 805 of communicating between a second computer readable medium (SCRM) and the e-mail account;
wherein the method additionally comprising steps of:
f. step 806 of determining by the monitor server activity status of the e-mail account according to a set of predetermined parameters; the parameters are in association with the performance of said software
g. step 807 of alerting the SCRM on the e-mail activity status by the monitor server.

In one embodiment of the current invention, at least one of the above mentioned first system, second system, third system, fourth system, first method, second method, third method or fourth method is disclosed, wherein the parameters are selected from a group consisting of: number of entries to an e-mail account selected from said N e-mail accounts, type of actions performed in an e-mail account selected from said N e-mail accounts, time length of being active in an e-mail account selected from said N e-mail accounts.

In one embodiment of the current invention, at least one of the above mentioned first system, second system, third system, fourth system, first method, second method, third method or fourth method is disclosed, wherein either one of the CRM, FCRM or SCRM is integrated in a device selected from a group consisting of: mobile device, personal computer, tablet, laptop and any other electronic device comprising communication mean.

In one embodiment of the current invention, at least one of the above mentioned first system, second system, third system, fourth system, first method, second method, third method or fourth method is disclosed, wherein each of at least one e-mail server or e-mail client or e-mail account comprises different set of parameter for identification of the activity status.

In one embodiment of the current invention, at least one of the above mentioned first system, second system, third system, fourth system, first method, second method, third method or fourth method is disclosed, communication between either one of CRM, FCRM, SCRM and with at least one of the N e-mail accounts is done via a third party.

In one embodiment of the current invention, at least one of the above mentioned first system, second system, third system, fourth system, first method, second method, third method or fourth method is disclosed, wherein the parameters are determined by external activity status software.

In one embodiment of the current invention, at least one of the above mentioned first system, second system, third system, fourth system, first method, second method, third method or fourth method is disclosed, wherein either one of server, monitor server or second server stores the monitor data in a data base.

In one embodiment of the current invention, at least one of the above mentioned first system, second system, third system, fourth system, first method, second method, third method or fourth method is disclosed, wherein either one of server, monitor server or second server alerts at least one of said N e-mail accounts on said activity status.

In one embodiment of the current invention, at least one of the above mentioned first system, second system, third system, fourth system, first method, second method, third method or fourth method is disclosed, additionally comprising at least one blocking module integrated in either on In one embodiment of the current invention, at least one of the above mentioned first system, second system, third system, fourth system, first method, second method, third method or fourth method is disclosed, e of e-mail server, e-mail client or e-mail account adapted to block the monitoring.

In one embodiment of the current invention, at least one of the above mentioned first system, second system, third system, fourth system, first method, second method, third method or fourth method is disclosed, wherein said monitoring server additionally analyses activity of said user of said e-mail server.

In some embodiments of the current invention, parameter for identifying a computer readable medium may be a phone number, a serial number, an IMEI number, a MAC address, an IP address, an instant messaging identity, a process number, a process memory address and any other parameter which identifies a computer or a program installed on a computer as well as any combination thereof.

In some embodiments of the current invention as disclosed. above, a user of an e-mail account might allow to share any of the predetermined parameters, a derivative or a combination thereof regarding his e-mail presence status with different watchers, employing a privacy mechanism where certain watchers might get the any of: the entire, partial, derivative or non- of the e-mail presence statuses. Selectively, different watchers can get different portions of the e-mail presence status.

For example, a first e-mail user gets an e-mail from a second e-mail user. The first user allows to share information about an e-mail being forwarded with the second e-mail user. The second e-mail user gets an e-mail presence status in the form of an alert, when the e-mail is being forwarded to a third e-mail user by the first e-mail user. The e-mail presence status may also include the time, the name and the address of the third e-mail user.

Its yet another example a first e-mail user gets an e-mail from a fourth e-mail user and forwards it to a fifth e-mail user. The first e-mail user does not allow to share the information about who is the fifth e-mail user, but only about the fact that the e-mail itself was indeed forwarded. The fourth e-mail user will get an alert that the e-mail was forwarded by the first e-mail user without revealing the name and the address of the fifth e-mail user.

In some embodiments of the current invention as disclosed above, data regarding activity of either one of the e-mail account, e-mail server, FCRM, any action performed on the FCRM, is stored for later analysis.

This analysis may differ from the “predetermined parameters” regarding the e-mail presence status determination, in the sense that analysis may produce data on the user behavior. For example, it may predict user behavior and change the e-mail presence status accordingly. Example of such user behavior e-mail presence status may be: “user is offline but will probably be available in two hours”, “user is online, but likely to answer e-mails in the morning”, “user is online during working hours, he will probably not respond during the weekend” etc.

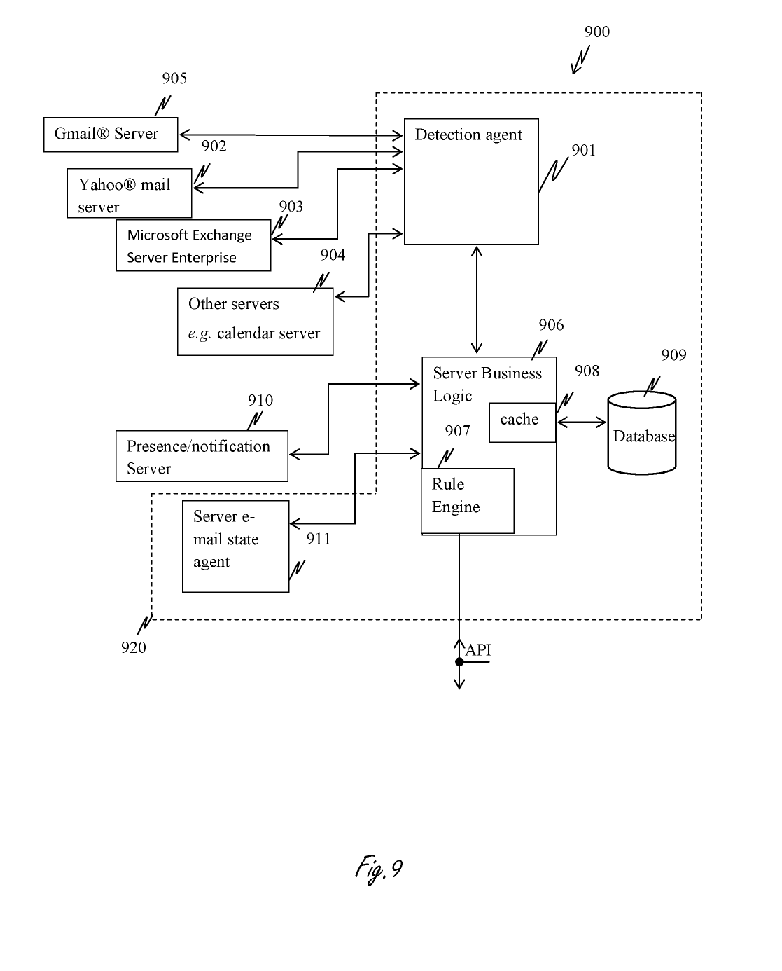

Reference is now made to FIG. 9 illustrating in a non-limiting manner, a system for deciding on an e-mail status. A detection agent 901 is communicating with different servers, such as: Gmail® 905, Yahoo mail server® 902, Microsoft Exchange Server Enterprise 903, and other servers 904. The detection agent 901 is connected to a server business logic module 906 having a rule engine 907 for operating server rules on data received from the detection agent 901. Rule engine 907 exposes an API to external modules for setting server rules. In addition, the server business logic module 906 has a cache 908 for storing data on top of a database 909.

The server business logic module 906 uses the server rules in order to determine and decide on the e-mail presence status of one the e-mail accounts or the user using them. The presence/notification server 910 is either a presence server known in the arts, implementing a subscribe/publish model, or a plain notification server that notifies a user of an e-mail presence status change. The notification can take place as either notify or fetch step. The recipient of the e-mail presence status is called Watcher User Agent (WUA) for simplicity, which is either a watcher subscribed to a presentity of one or more e-mail presence statuses in the case of a presence server or merely an authorized recipient in the case of plain notification server. In addition, there is an e-mail state agent server 911, extracting (by either notify or fetch step) the e-mail predetermined parameters.

Reference is made again to FIG. 9 where the elements of detection agent 901, server business logic 906, database 909, and server e-mail state agent 911, are all integrated into a unit of a monitor server 920.

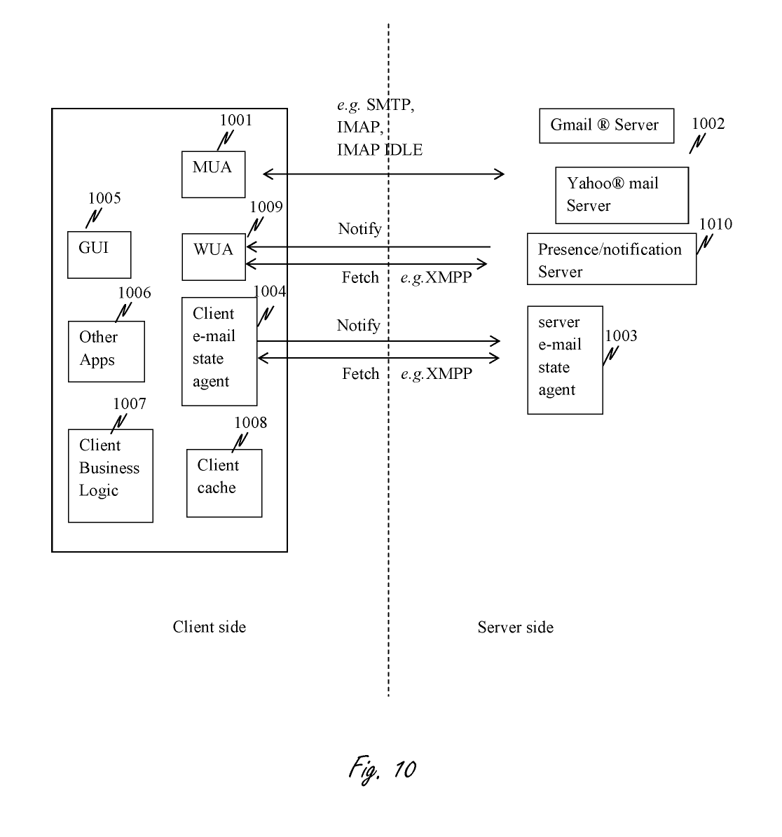

Reference is now made to FIG. 10 illustrating in a no limiting manner, the client side and the server side of the above mentioned system. The client is having different modules, such as a GUI, a client e-mail state agent, a cache etc. It also has an MUA 1001 communicating via one or more e-mail protocols with e-mail servers 1002. The servers (for example the server e-mail state agent 1003 is either receiving notification or fetching vita a communication protocol (e.g. XMPP) with the client e-mail state agent 1004 operating on the client side. client e-mail state agent 1004 extracts predetermined parameters from MUA 1001 and from other apps 1006 (e.g. detecting information from iOS Notification Center on the Apple iPhone device) and in some cases analyses the information at client business logic module 1007 before transferring it to sexy mail state agent 1003.

Reference in now made again to FIG. 10, illustrating in a non-limiting manner, the communication flow between the client side and the server side. The presence or notification server 1010 delivers data to the WUA 1009 in the client side in two steps fetch and notify (i.e. through an API). The same goes to the client e-mail state agent 1004 communicating with server e-mail state agent 1003 by notify and fetch steps.

Other modules installed on the client side may be GUI 1005. Data is stored in the client cache 1008.

In some embodiments of the current invention as disclosed above, actions performed on the e-mail account or one or more of the e-mails contained in the e-mail account are updated in the predetermined parameters.

In some embodiments of the current invention as disclosed above, the rule engine being part of server business logic module 906 takes into account generic server rules, server rules on a user basis, server rules on an e-mail account basis as well as, among others, server rules on per device, sender, recipient, subject, keywords, language, time and location. The rule engine applies the server rules on the predetermined parameters. The rule engine module 907 implements privacy mechanism where certain watchers such as WUA 1009 are allowed to subscribe to portions of e-mail presence statuses of a specific e-mail account. The server rules determine on a per e-mail account, who is allowed to get which e-mail presence status and whether in full or in part.

Server business logic module 906 takes into account multiple predetermined parameters and outputs of its rule engine module 907 to analyze the predetermined parameters and create multiple e-mail presence statuses for each of the e-mail accounts at any given time or as triggered by the arrival of one or more new values of predetermined parameters. The e-mail presence statues are then sent to the presence/notification server module 910 which distributes the information to different WUAs.

In some embodiments of the current invention as disclosed, above, e-mail account can forward e-mails to another account or program responsive to receiving automatically or temporarily an e-mail or its subset (e.g. notification of subject only). When the forwarded instance of the e-mail or its subset is being accessed or any other action is performed on it by the user, depends on its business logic and rule engine, the system might treat an access or an action performed on a forwarded instance of the e-mail or its subset, similarly to accessing or performing an action of the original copy of the e-mail and update the predetermined parameters accordingly and subsequently the e-mail presence status.

In some embodiments of the current invention as disclosed above, e-mail account rules are a set of rules determined by the account user, account administrator, spam filter or any other 3^{rd} party or application. The e-mail account rules perform actions on e-mail account whether regularly, from time to time, or triggered as a response to an action performed on the e-mail account. E-mail account rules may reside on the e-mail server, the e-mail client, or on any proxy in between. The system is capable of taking these e-mail account rules into account within the business logic and rules engine modules while ignoring an action which is triggered by an automatic e-mail account rule or an administrator. Thus, the related predetermined parameters would be marked as actions triggered by automatic e-mail account rules which may not affect the e-mail presence status of the related e-mail account.

In some embodiments of the current invention as disclosed above, multiple e-mail clients on same device and/or on multiple devices are configured with the same e-mail account. Actions performed on the e-mail account through one or more of the e-mails clients are recorded within the predetermined parameters, and the e-mail presence status might be affected in a segmented way advising the e-mail account status on a per e-mail client and/or device basis,

In some embodiments of the current invention as disclosed above, an e-mail account user or a 3^{rd} party might choose to run in an invisible mode which occurs either at the level of blocking the monitoring server from accessing the e-mail account and/or the level of the business logic module which prevents the e-mail e-mail presence status from being shared with watchers/recipients. A user might elect to completely block the e-mail presence status from recipients or selectivity share the e-mail presence status with some recipients employing a privacy mechanism within the Business logic. Similarly, users may elect to have a manual e-mail presence status always online, invisible mode), a time-dependent e-mail presence status (online between 8 am to 5 pm, offline otherwise) or a location aware e-mail presence status (online at the office, offline when home).

### Example 1

In one example of the current invention, a first user would like to send to a second user an e-mail message. A monitoring server is communicating with the e-mail server and monitors the second user activity in his e-mail account.

In case the second user sent three messages in the past half an hour, the monitoring server decides that the second user e-mail presence status is: “active”. A notification of this status is sent to the first user's e-mail account.

### Example 2

In another example of the current invention, a user is provided with a first mobile device, this first mobile device is communicating with an e-mail server, and has other applications installed on it. One of these applications is an instant messaging application communicating with a second mobile device.

A monitoring server is communicating with both mobile devices. The monitoring server detects the activity of the instant messaging application on the first mobile device directly or through an e-mail state agent client, and in case the application communicated with three different users in the last 20 minutes, it sets the e-mail presence status to: “active”, this e-mail presence status is then sent to the e-mail client on the second mobile device.

### Example 3

In another example of the current invention a tablet is provided with an e-mail program integrating 3 e-mail accounts. In addition, an instant messaging (IM) application is installed on a tablet, the instant messaging program is operated via a server. Any message sent or received by the IM is going through the server. A monitoring server is connected to the IM server and counts the data transferred to the tablet by the IM application, once the data size exceeds X byte, the monitoring server sets the e-mail presence status of all 3 e-mail accounts to be “online”.

A user having a mobile device is communicating with the owner of the tablet through the IM application (and as a result is having an identification parameter of the tablet owner), the e-mail presence status is sent to the user of the mobile device through the IM application.

### Example 4

In another example of e current invention, an e-mail server is in communication with a monitoring server. However, the server has a program installed on it, which allows a client of an e-mail account to disable access of the monitoring server to his account. Thereby, preventing the ability to determine the e-mail presence status.

### Example 5

In another example of the current invention, GOGGLE Glass® are connected to FACEBOOK® and to GMAIL® e-mail account. An external server is connected to these glasses through a WiFi connection. A FACEBOOK® notification appears to the user on the glasses display. The server detects this notification, and sets the e-mail account status to be “operating on GOGGLE® Glass”.

### Example 6

An e-mail account has a set e-mail rule to automatically forward all received e-mails to a second e-mail account. The user logs into the second e-mail account which is being monitored by the detection agent. The detection agent detects the user has read the e-mails arrived from the first e-mail account recently. This information is sent to the business logic and its rule engine, which in turn decide that the user is currently “online” at both e-mail accounts.

### Example 7

An iOS mobile device has an e-mail application installed on it. The e-mail application is connected to an e-mail server using IMAP and SMTP protocols. In addition, the e-mail server is connected to the Apple Push Notification service (APNs). When an e-mail is received by the e-mail server it pushes a notification to the iOS mobile device through the APNs. When a user opens up the notification (which is usually a subset of the e-mail) the predefined parameters will be updated and the e-mail status will change to “online” or “able to read notifications”

### Example 8

A mobile device user opens his e-mail via an e-mail application installed on his device. He sends an e-mail to a first friend, the data relating to this activity is sent to the monitor server. The monitor server, then sends a notification stating “e-mail sent t minutes ago” to a second friend The t indicates the time passed from sending the e-mail and is updated continuously.

### Example 9

A mobile device user reads and deletes an e-mail via an e-mail application installed on his device. The e-mail was sent from a first friend and the data relating to these actions is sent to the monitor server. The monitor server, then sends a notification stating “your e-mail was read and deleted” to the first friend.

### Example 10

A mobile device accepts a meeting through his calendar application installed on his device. The action is detected by the client e-mail state agent which in turn is sent to the monitor server. The monitor server, then sends a notification stating “active for email and calendar” to the work-related watchers subscribed on his e-mail presence statuses, other watchers will not get these notification as a server rule was set in advance to allow only work-related watchers to receive calendar extracted e-mail presence status.

1. A system for alerting on an e-mail activity status comprising:
a. at least one e-mail server having first instructions thereon for integrating N e-mail accounts; said N is an integer larger than zero;
b. at least one second server in communication with said e-mail server; said at least one second server is adapted to monitor at least one of said e-mail server;
c. at least one computer readable medium (CRM) adapted to receiving an e-mail alert;
wherein said at least one second server identifies activity status in at least one of said e-mail server according to a set of predetermined parameters; further wherein said at least one second server alerts said CRM on said activity status.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A method for alerting on an e-mail activity status comprising steps of:
a. connecting via a monitor server, to an e-mail server integrating N e-mail accounts; said N is an integer larger than zero;
b. monitoring via said monitor server, activity of a first e-mail account selected from said N e-mail accounts;
c. providing a computer readable medium (CRM) adapted to receive an e-mail alert from at least one of said N e-mail accounts;
wherein said method additionally comprising steps of:
d. determining activity status of said e-mail server according to a set of predetermined parameters; and
e. alerting said CRM on said activity status.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A system for alerting on an e-mail activity status comprising:
a. at least one e-mail client having first instructions thereon for integrating N e-mail accounts; said N is an integer larger than zero;
b. at least one e-mail agent adapted to identify e-mail client activity;
c. at least one server in communication with said e-mail agent; said at least one server is adapted to monitor at least one of said e-mail agent;
d. at least one computer readable medium (CRM) adapted to receive e-mail alert from at least one of said N e-mail accounts;
wherein said at least one server identifies activity status in at least one of said e-mail client according to a set of predetermined parameters; further wherein said at least one server alerts said CRM on said activity status.

26. (canceled)

27. (canceled)

28. (canceled)

29. (canceled)

30. (canceled)

31. (canceled)

32. (canceled)

33. (canceled)

34. (canceled)

35. (canceled)

36. A method for alerting on an e-mail activity status comprising steps of:
a. connecting via a monitor server, to an e-mail agent; said e-mail agent is associated with an e-mail client integrating N e-mail accounts; said N is an integer larger than zero;
b. monitoring via said monitor server, activity of a first e-mail account selected from said N e-mail accounts;
c. providing a computer readable medium (CRM) adapted for receiving e-mail alert from at least one of said N e-mail accounts;
wherein said method additionally comprising steps of:
d. determining activity status of said e-mail client according to a set of predetermined parameters; and
e. alerting said CRM on said activity status.

37. (canceled)

38. (canceled)

39. (canceled)

40. (canceled)

41. (canceled)

42. (canceled)

43. (canceled)

44. (canceled)

45. (canceled)

46. (canceled)

47. A system for alerting an e-mail activity status comprising:
a. a first computer readable medium (FCRM) having first instructions thereon for (i) executing a plurality of N actions; and (ii) retrieving information associated with at least one e-mail account; said N is an integer larger than zero;
b. at least one server in communication with said FCRM; said at least one server is adapted to monitor performance of at least one first action selected from said N actions;
c. a second computer readable medium (SCRIM) having second instructions thereon for receiving notification associated with said first action;
wherein said at least one server determines activity status of said e-mail account according to a set of predetermined parameters; said predetermined parameters are in association with said performance of said at least one first action; further wherein said
at least one server alerts said SCRM on said e-mail activity status.

48. (canceled)

49. (canceled)

50. (canceled)

51. (canceled)

52. (canceled)

53. (canceled)

54. (canceled)

55. (canceled)

56. (canceled)

57. (canceled)

58. A method for alerting an e-mail activity status comprising steps of
a. communicating by a monitor server, to a first computer readable medium (FCRM) operating N actions; one of said actions is retrieving information associated with at least one e-mail account; said N is an integer larger than zero;
b. monitoring by said monitor server, performance of at least one first action selected from said N actions;
c. communicating between a second computer readable medium (SCRM) and said first action;
wherein said method additionally comprising steps of
d. determining by said monitor server activity status of said e-mail account according to a set of predetermined parameters;
e. alerting said SCRM on said e-mail activity status by said monitor server.

59. (canceled)

60. (canceled)

61. (canceled)

62. (canceled)

63. (canceled)

64. (canceled)

65. (canceled)

66. (canceled)

67. (canceled)

68. (canceled)

69. A system for alerting an e-mail activity status comprising:
a. a first computer readable medium (FCRM) having first instructions thereon for (i) executing a plurality of N actions; and (ii) retrieving information associated with at least one e-mail account; said FCRM is having at least one identification parameter; said N is an integer larger than zero;
b. at least one first server in communication with said FCRM; said at least one first server receives notification of (i) at least one first action selected from said N actions; and (ii) said at least one identification parameter;
c. at least one second server in communication with said first server; said at least one second server is adapted to monitor performance of at least one of said first action;
d. a second computer readable medium (SCRM) having second instructions thereon for communicating with said first action;
wherein said at least one second server determines activity status of said e-mail account according to (i) a set of predetermined parameters; and (ii) said at least one identification parameter; said predetermined parameters are in association with said performance of said at least one first action; further wherein said at least one server alerts said SCRM on said activity status.

70. (canceled)

71. (canceled)

72. (canceled)

73. (canceled)

74. (canceled)

75. (canceled)

76. (canceled)

77. (canceled)

78. (canceled)

79. (canceled)

80. A method for alerting an e-mail activity status comprising steps of:
a. communicating between (i) at least one software operating on a first computer readable medium (FCRM) associated with at least one e-mail account; and (ii) said software server;
b. receiving by said software server: (i) notification on activity of said software; and (ii) identification of said CRM;
c. communicating between (i) a monitor server; and (ii) said software server;
d. monitoring by said monitor server, performance of said software;
e. communicating between a second computer readable medium (SCRM) and said software;
wherein said method additionally comprising steps of:
f. determining by said monitor server activity status of said e-mail account according to a set of predetermined parameters; said parameters are in association with said performance of said software
g. alerting said SCRM on said e-mail activity status by said monitor server.

81. (canceled)

82. (canceled)

83. (canceled)

84. (canceled)

85. (canceled)

86. (canceled)

87. (canceled)

88. (canceled)

89. (canceled)

90. (canceled)
